(19) United States
(12) Patent Application Publication
(10) Pub. No.: US 2011/0017530 A1
(43) Pub. Date: Jan. 27, 2011

(54) FASTENING DEVICE AND WORK VEHICLE, IN WHICH THE FASTENING DEVICE IS APPLIED

(75) Inventor: Mauno Keski-Luopa, Lahti (FI)

Correspondence Address: YOUNG & THOMPSON, 209 Madison Street, Suite 500, Alexandria, VA, 22314, US

(73) Assignee: ACTIONECO OY, Lahti (FI)

(21) Appl. No.: 12/745,586

(22) PCT Filed: Nov. 28, 2008
(86) PCT No.: PCT/FI08/50697

§ 371 Date: Oct. 12, 2010

(30) Foreign Application Priority Data
Nov. 29, 2007 (FI) 20070922

(51) Int. Cl. F16B 2/12; B60K 1/00; B62D 63/02

(52) U.S. Cl. 180/65.1; 403/350

(57) ABSTRACT

A fastening device for detachably fastening a supplementary apparatus to a main apparatus with a part belonging to it, such as a rod, pin, projection, shaft, or similar, includes a longitudinal frame (2) and slide (3), which are attached and fitted to each other so that they can be moved in relation to each other between two positions (A, B) and in the connection of which there are provided the first and, respectively, the second closing part (4, 5), via which the rod of the supplementary apparatus etc. can be attached to the fastening device and to the apparatus etc., and a locking element (6) for immovably locking the frame (2) and slide (3) to each other and, respectively, for releasing them from each other. A work vehicle, in which the fastening device is applied is described.

The invention relates to a fastening device according to the preamble of claim 1.

The invention also relates to a work vehicle, in which the fastening device is applied.

In this connection a fastening device is understood to be an apparatus, by means of which a supplementary apparatus can easily and fast be attached to the main apparatus and, respectively, release from it. Previously there are known different kinds of fastening devices. A common problem with these is that in most cases a tool of some kind is needed to attach and release the supplementary apparatus. This means that the fastening and/or release of the supplementary apparatus are laborious and time-consuming.

A purpose of the invention is to eliminate problems related to known fastening devices. It is also a purpose of the invention to achieve an improved fastening device with, among others, a simple structure and low manufacturing costs.

The fastening device of the invention is characterised in what is disclosed in claim 1. The dependent claims 2-7 disclose advantageous embodiments of the invention.

One advantageous embodiment of the fastening device is a work vehicle that can be moved independently by an own driving motor, to which different work devices can be attached. In this case, the work vehicle is the main apparatus and the work device the supplementary apparatus.

The work vehicle of the invention is characterised in what is disclosed in claim 8. The dependent claims 9-10 disclose advantageous embodiments of the work vehicle.

One advantageous example of a combined work vehicle and work device is an independently movable and drivable grass-cutting apparatus. The work vehicle comprises a frame, which is provided with wheels, at least one driving motor, a seat for the user of the work vehicle with control and regulating equipment nearby, and a supplementary apparatus i.e. the cutting unit, which is detachably attached to the driving machine with a fastening device of the invention and with which the cutting of grass or similar is performed. In addition to the said cutting unit, also other work devices can be preferably connected detachably to the work vehicle with the fastening device; for example, a brushing device and/or a snow clearance device for clearing snow, or generally work devices used for the upkeep of courtyard or grass areas.

It is an object of the invention to make the fastening and connecting in general of work devices to a work vehicle simple, fast and easy, likewise its release.

It is also an object of the invention to achieve a new improved work vehicle, to which at least one type of a work device, most preferably however work devices or equipment suitable for different tasks can be easily and securely attached and respectively detached.

The invention and its other advantages are next explained in detail, referring to the enclosed drawing in which:

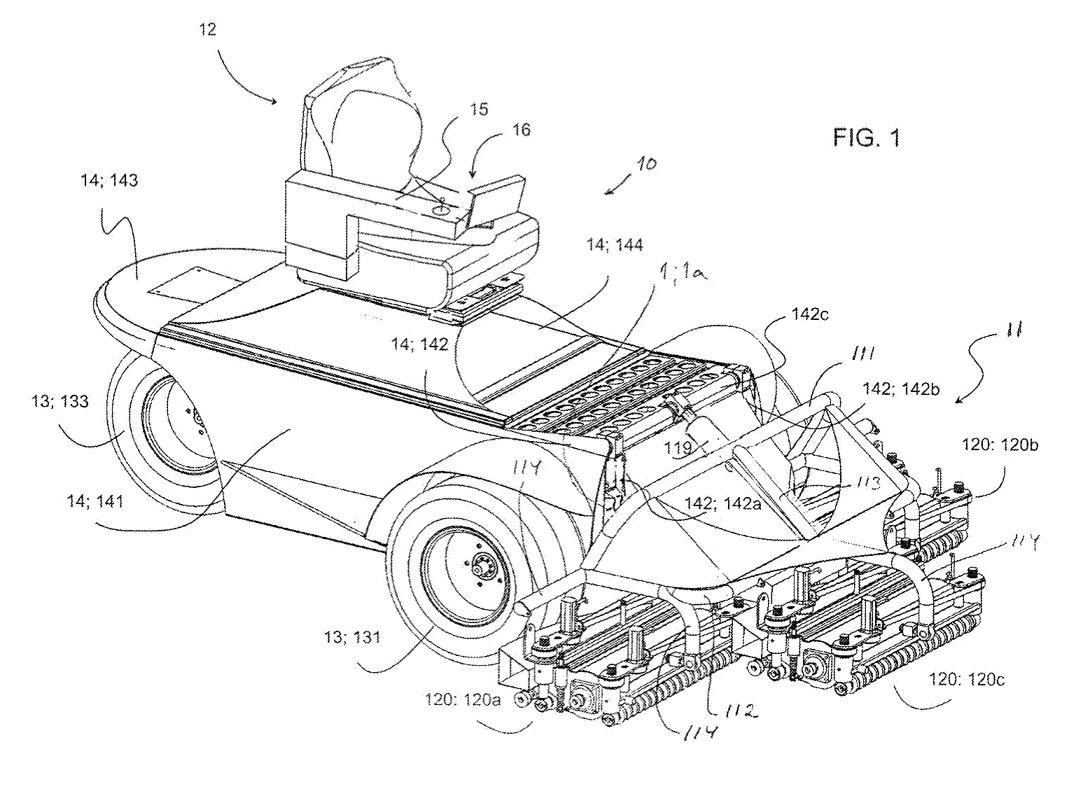

FIG. 1 illustrates a work vehicle with a work device, in this case a grass-cutting apparatus attached to it, seen obliquely from above;

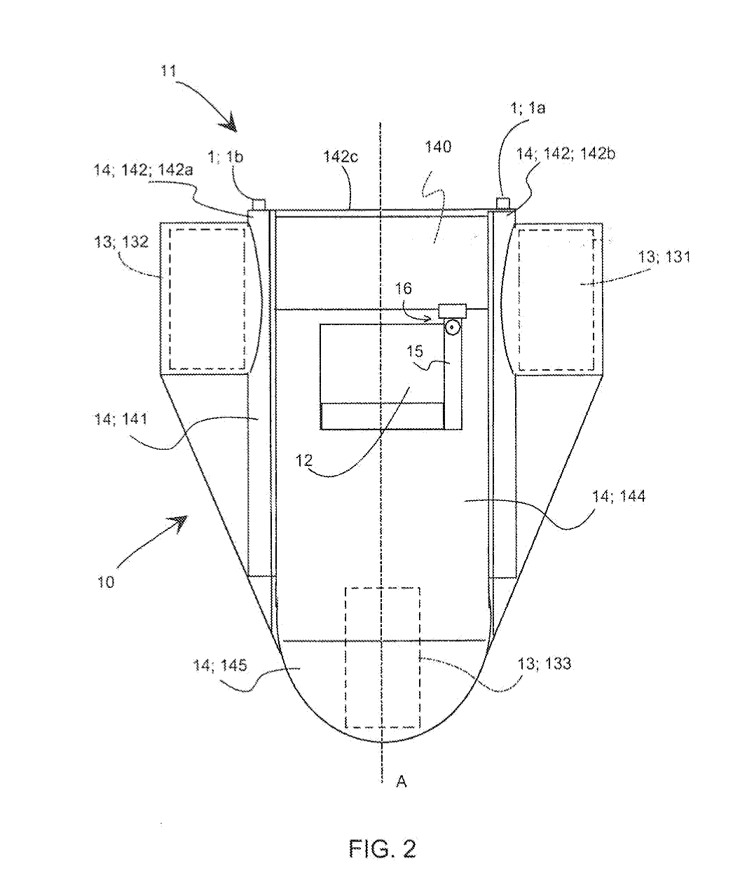

FIG. 2 is a top view of the work vehicle;

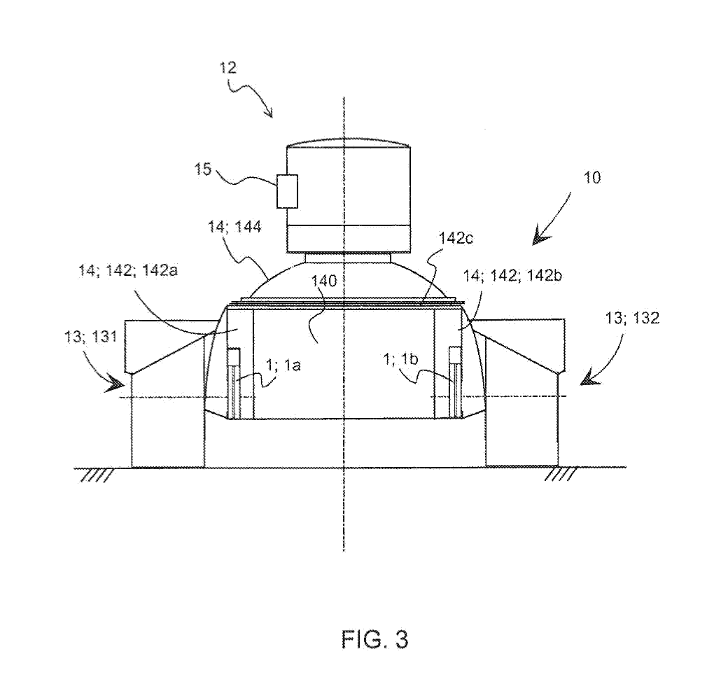

FIG. 3 is a front view of the work vehicle;

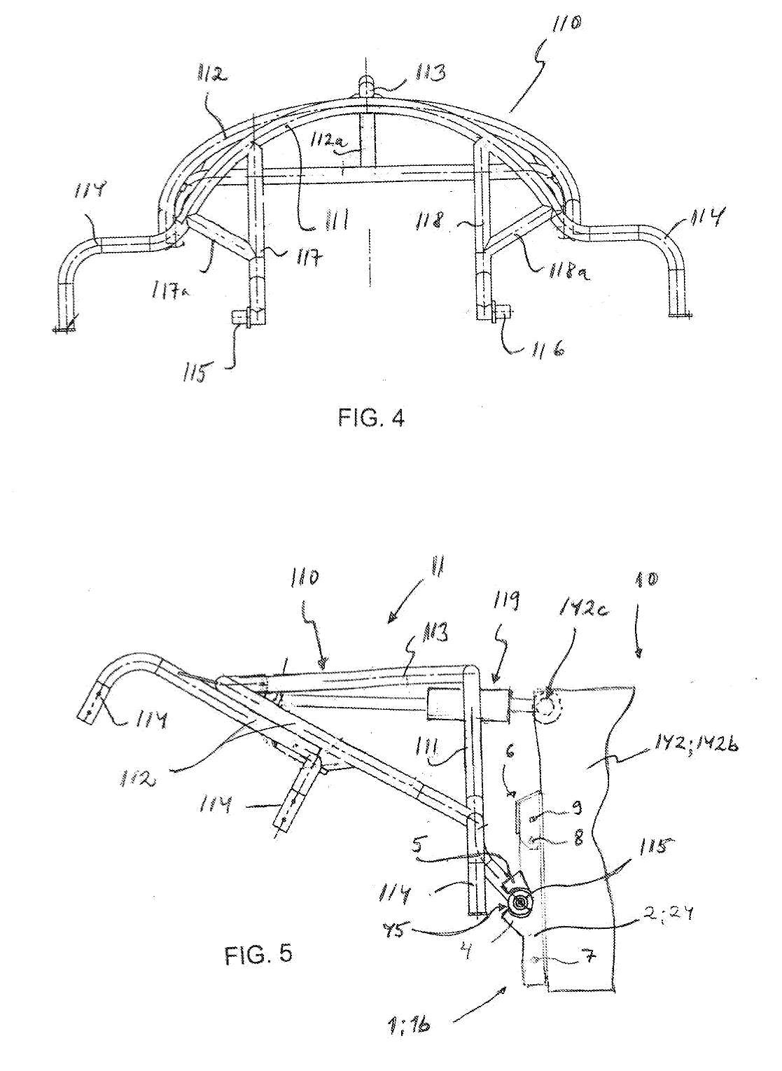

FIG. 4 is a rear view of the support frame of the work vehicle;

FIG. 5 illustrates the support frame of the work vehicle seen from the side, and its connection to the work vehicle by means of a fastening device;

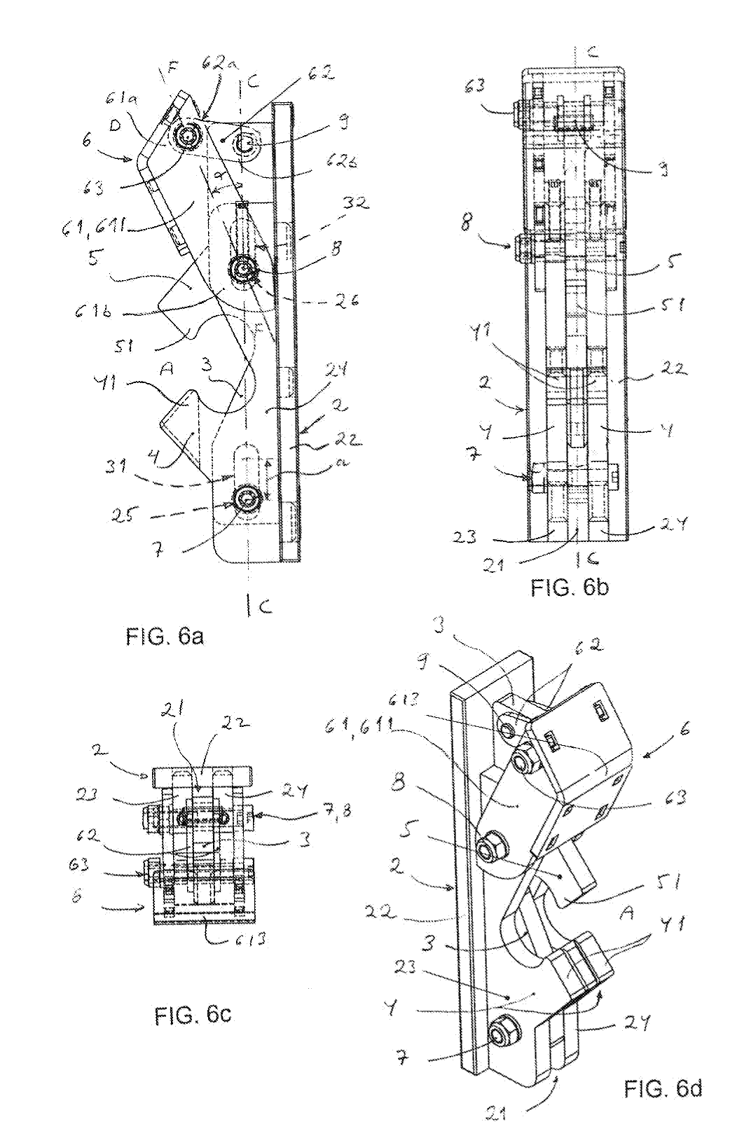

FIG. 6a is a side view of the fastening device in an open position;

FIG. 6b is a front view of a respective fastening device;

FIG. 6c is a front view of a respective fastening device; and

FIG. 6d illustrates a respective fastening device seen obliquely from above;

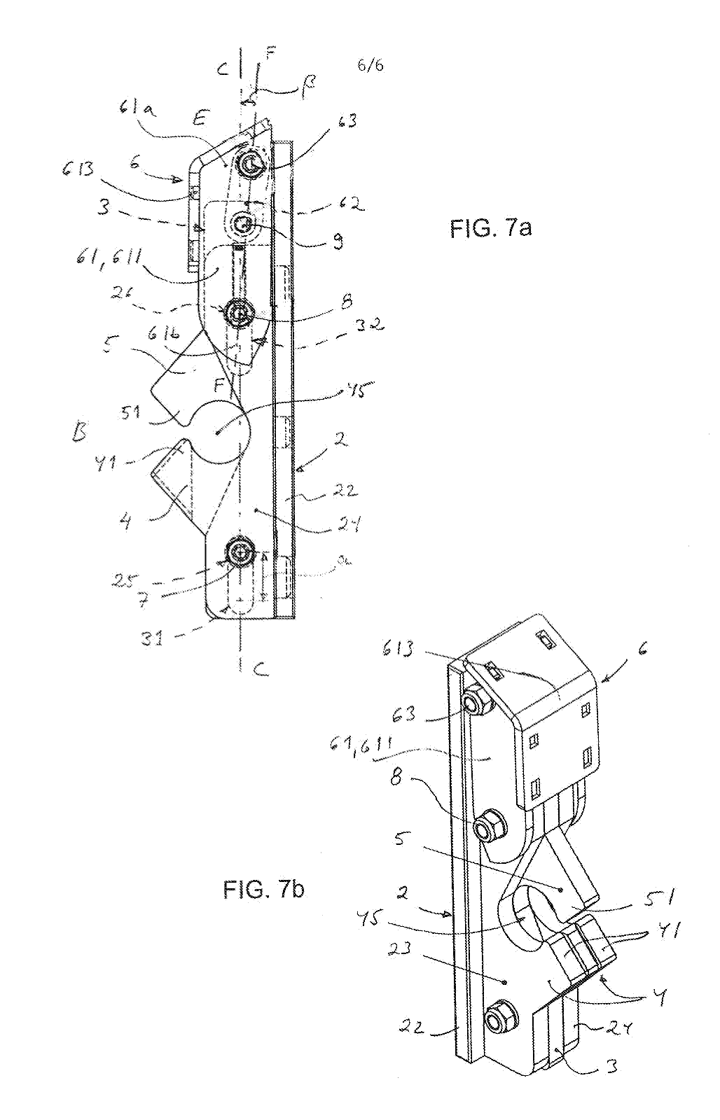

FIG. 7a is a side view of the fastening device in a closed position; and

FIG. 7b illustrates a respective fastening device seen obliquely from above.

The same reference numbers are used of parts that correspond to each other.

FIG. 1 illustrates an advantageous example of the work vehicle 10, to which the work device 11 is attached. This assembly is an independently movable, adjustable and drivable apparatus, i.e. in this case the grass-cutting apparatus 100. The work vehicle 10 comprises the frame 14, which is provided with the wheels 13 and at least one driving motor unit, the seat 12 for the user of the work vehicle, and the control and regulating equipment 16 near the seat.

The work device, in this case the grass-cutting apparatus, is detachably attached to the work vehicle 10 by at least one, more preferably by two fastening devices 1; 1a, 1b of the invention (see FIGS. 2-4), with which work device the cutting of grass or similar is performed. In addition to the said grass-cutting apparatus, it is possible to detachably attach to the work vehicle 10 also other work devices with the fastening device 1, such as a brushing apparatus and/or a snow-clearance apparatus for clearing snow.

The frame 14 of the work vehicle 10 has most preferably been realised as a self-supporting structure. In this case, the frame 14 itself is a rigid and form-retaining entity without special support structures. The frame 14 comprises the middle frame 141, the end sections integrally connected to it, i.e. the front and back section 142, 143, and the upper section 144. The middle frame 141 is a longitudinal basin-like space in the longitudinal direction of the axis of the frame, and it is open from the top. The middle frame 141 is covered by the upper section 144 of the frame. A space e.g. for batteries, control units (and an alternative driving motor unit) has been arranged to the middle frame 141.

In a preferable frame 14 of the work vehicle 10, its front section 142 forms a fork. In this case, the front section 142 comprises two fork parts 142a, 142b, with the space 140 between them. In this embodiment, the space 140 is reserved for such a container, into which lawn cuttings are collected from the cutting apparatus 11.

In this embodiment, the work vehicle 10 is provided with the seat 12 for the driver and user of the work vehicle and work device. The seat 12 is arranged onto the frame 14, especially to the upper section 142 of the frame. Near the seat 12 and, at the same time, close to the user there is provided the control projection 15 or a similar organ containing the control and driving equipment 16 for adjusting and maintaining the run and functions of the work vehicle 10 and the work device 11.

The work vehicle 10 is provided with at least three bearing wheels 13; 131, 132, 133, of which one pair of wheels 131, 132 is located at the end of the apparatus frame 14, such as on opposite sides in the front section 142, and one wheel 133 at the opposite end of the frame in relation to this pair of wheels, i.e. in the back section 143. Alternatively, there are four wheels 13, which are arranged in pairs to the frame of the work vehicle.

The work vehicle 10 is preferably electrically operable, and its one or several driving motor units then comprise an electric motor, especially an alternating-current switching motor. The driving motor unit is most preferably arranged in contact with both wheels in the pair of wheels 13; 131, 132 of the work vehicle. The user of the work vehicle 10 and the work device 11 controls and regulates the operation of the driving motor units by means of a control unit using the control and driving equipment 16 arranged to the control projection 15 of the apparatus. The driving motor unit preferably includes, in addition to the electric motor, also a gear, especially a reduction gear, for reducing the rotation speed of the electric motor to be suitable for the work vehicle.

However, it shall be noted that the driving motor unit can also be realised with a combustion engine or a hybrid engine, but in this case it has to be arranged to the middle frame 14; 141, and the power transmission is carried out by suitable transmission equipment most preferably to the two front wheels 13; 131, 132.

The work device 11, in this case an apparatus for cutting grass or similar, is attached to the end of the frame 14, especially its front section 142. The cutting apparatus comprises a number of cutting units 120, the number of these being three 120a, 120b, 120c in the work device according to FIG. 1. These cutting units 120 are most preferably arranged partly side by side, but partly also in an overlapping and successive arrangement, depending on the size of the apparatus and the number of cutting units so that as wide a grass area as possible can be cut in a uniform and even manner when moving the apparatus forward.

In the work device 11 the actual work equipment, i.e. in this case the cutting units 120, are attached to the support frame 110. The end of the frame 14 of the work vehicle 10, especially, the front section 142, is provided with at least one fastening device 1 for the work device 11; in this case two fastening devices 1a, 1b. The cutting units 120 can be detachably attached to the frame 14 of the work vehicle 10 via the support frame 110 through the fastening device 1; 1a, 1b.

The support frame 110 of the work device 11 comprises two fastening pins or rods 115, 116 with a circular cross-section and arranged at a distance to each other; the axes of the fastening pins or rods being parallel. The fastening pins 115, 116 can alternatively be realised as a projection or sleeve with a circular cross-section that can be supported from one end or both ends either directly to the support frame 110 or to projections or similar support structures arranged in it. In one alternative, both fastening pins 115, 116 at a distance can be connected to each other so that they form a uniform straight fastening rod.

These fastening pins 115, 116 are accommodated to fastening devices 1; 1a, 1b at the corresponding distance from each other, when the work device 11 is to be attached to the work vehicle 10. The fastening pins 115, 116 and at the same time also the support frame 110 with its work equipment (and thus the whole work device 11) can rotate perpendicularly to the axis passing through them. In addition, the actuator 119 is arranged between the support frame 110 of the work vehicle and the work vehicle 10, by means of which the support frame 110 and thus the whole work device 11 can be rotated in the said manner, especially from the working position to the rest position (transport position), and vice versa.

In the embodiment shown, the support frame 110 is a tubular frame. It has thus been made of tubular parts connected to each other. The support frame 110 can then be made light, rigid and stress-resistant. The support frame 110 comprises the upper frame part 111 and the lower frame part 112 at an angle to the upper frame part, the parts being connected to each other from the end areas of these frame parts. In addition, the frame parts 111, 112 are connected to each other from the middle by the central support part 113. In this case, the frame parts 112, 113 comprise at least partly curved tubular parts and possible support parts 112a. The central support part 113 is preferably a straight (or curved) tubular part. A number of arms 114 that are short tubular parts are attached to the lower frame part 112, and the cutting units 120; 120a, 120b, 120c are suspended on these. The two fastening pins or rods 115, 116 of the support frame at a distance from each other and with parallel longitudinal axes, are supported and connected to the upper frame part 111 by tubular support parts 117, 118, to which additional supports 117a, 118a are fastened for making the structure more rigid, when necessary.

The support frame 110 has been shown above by illustrating an advantageous structure suitable for it, but it is obvious that it can be carried out in many different ways, depending e.g. on the work equipment accommodated in the work vehicle 10 and connected to the support frame.

The fastening device 1; 1a, 1b for detachably attaching a supplementary apparatus, such as the above-mentioned work device 11, to the main apparatus, such as the said work vehicle 10, by means of a part belonging to it, such as the said fastening pin 115, 116 of the support frame or a similar rod, projection, shaft etc, comprises at least the following parts (see FIGS. 6a, 6b, 6c, 6d, and FIGS. 7a, 7b). The fastening device 1 has the longitudinal frame 2 and the slide 3, which are attached and fitted to each other so that they can be moved in relation to each other between two positions, the first or the open position A and the second or the closed position B. In connection with the frame 2 and the slide 3 of the fastening device 1 there are also provided the first and the second closing part 4, 5, by means of which the fastening pin 115, 116 of the supplementary apparatus, such as the work vehicle 10, or a similar fastening part of a work device can be attached to the fastening device and by means of that further to the work vehicle. In addition, the fastening device 1 has locking means 6 for locking the frame 2 and the slide 3 immovably to each other and, respectively, for releasing them from each other.

In an advantageous embodiment of the fastening device 1, the frame 2 is most preferably provided with the straight, groove 21, into which the slide 3 is fitted. In this groove 21, the slide 3 can be moved at least for a fixed distance a, i.e. the distance of motion from the first position A to the second position B and back, respectively. Alternatively, the frame 2 comprises the groove 21, which consists of a number of successive groove parts. These groove parts are most preferably arranged to a straight line.

The frame 2 and the slide 3 of the fastening device 1 are attached to each other by at least two first and second connecting pins 7, 8, the motion axis C-C of the slide 3 travelling through their centres. The connecting pins 7, 8 are arranged to travel perpendicularly in relation to the motion axis C-C through the apertures 25, 31; 26, 32 of the frame 2 and the slide 3. Of these apertures, the slide apertures 31, 32 are longitudinal with the length of at least the length of the allowed distance of motion. The slide 3 can now move in relation to the frame 2 between the open position A the closed position B. At the same time, the first and, respectively, the second closing part 4, 5 can be moved from the position, in which they are close to each other, to a position in which they are at a distance from each other so that the fastening pin or similar of the work device can be fitted into the space between them.

In an advantageous embodiment of the invention the first 4 and respectively the second closing part 5 in connection with the frame 2 and slide 3 of the fastening device 1 are substantially uniform hook-like parts. In addition, they are arranged opposite each other so that their free ends 41, 51 point towards each other. The free ends 41, 51 of the first and second closing part 4, 5 of the fastening device are in the proximity of each other, either side by side or at least close to each other in the second position, i.e. the closing position B. In this case the closing parts 4,5 together form a substantially closed circle with the space 45 for the fastening pin 115; 116 or a similar rod remaining inside, into which it can be locked in the closing position B (cf. FIG. 5). The circumference of the space 45 between the closing parts 4, 5 for the fastening pin 115, 116 is substantially circular or at least close to this, and its diameter corresponds substantially to the diameter of the fastening pin. In this case, the fit between the closing parts 4, 5 and the fastening pin 115, 116 to be accommodated between them is substantially tight, and there is hardly any play between them, or the play is small. Respectively, when the free ends 41, 51 of the hook-like closing parts 4, 5 are at a predetermined distance (corresponding to the distance of motion a of the slide 3) from each other in the second position, i.e. the open position A, the fastening pin 115; 116 or similar can be fitted between the closing parts 4, 5, or it can be removed from between the closing parts 4, 5. Thus the diameter of the fastening pin 115, 116 is at its minimum equal to or slightly smaller than the said predetermined distance i.e. the distance of motion a.

In a preferable embodiment of the fastening device the locking means 6 comprise the first 61 and the second lever 62, which are connected rotatably to each other by the fastening pin 63 at the first end 61 a, 62a of both levers. In addition, the second end 61b of the first lever 61 is rotatably attached to the second connection pin 8 and via this to the frame 2 and the slide 3. The second end 62b of the second lever 62 is rotatably attached to the third connection pin 9, which is in the upper part of the frame 2 most preferably outside the area of motion of the slide 3, in this embodiment especially above. The axis of the third connection pin 9 is on the line of motion C-C or in its close proximity. The locking means 6 (i.e. the levers 61, 62 with their fastening pin 63) can be rotated over the motion axis C-C with the second and third connection pin 8, 9 as reversing points from its first side, i. e. the release position D, to the second side, i.e. the locking position E, and vice versa. In this case the locking means 6 are thus in the release position D, when the line F-F travelling through the midpoints of the fastening pin 63 and the second connection pin 8 i.e. in this case the axis of the first lever 61 is at a positive angle a in relation to the line of motion C-C, i.e. it is on the side of the closing parts 4, 5 and respectively in the locking position E, when the axis of the first lever 61 and the line F-F are at (a small) negative angle β to the line of motion C-C, i.e. the lever 61 is turned towards the frame 2, especially the bottom part 22 of the frame. In the locking position E, the end 61 a of the first lever 61 is turned against the frame 2 or at least near the frame 2 so that the slide 3 can be locked immovably to the second position, i.e. the closed position B. The possible force applied to the closing parts 4, 5, which tends to open the closing parts and move the slide 3 from the position B to the position A influences the “wrong” side (angle β) in relation to the motion axis C-C and thus more or less makes the closing parts 4, 5 to stay more tightly in the closed position B than opens it.

The connection pins 7, 8, 9 and the fastening pint 63 are made e.g. by means of a rod, sleeve, screw or bolt.

In an advantageous embodiment of the fastening device, the first lever 61 is made by means of two parallel lever arms 611, 612. They are arranged to different sides of the side parts 23, 24 of the frame 2 and, at the same time, of the groove 21. The upper part of the first lever 61 is provided with the cover plate 613 connecting the lever arms 611, 612. This makes it easy to grasp the first lever 61 and to turn the first and second lever 61, 62 to the desired direction; either to the locking position E or the release position D. Respectively, also the second lever 62 is in this embodiment made by means of such two parallel lever arms, which are arranged to different sides of the slide 3.

The work device 11, such as a cutting apparatus, is detachably attached to the work vehicle 10, especially to its frame 8 most preferably with two fastening devices 1; 1a, 1b disclosed above. The longitudinal frames 2 of the two fastening devices are attached to the end section of the frame 14 of the work vehicle 10, especially to the front section 142, essentially at the same, especially horizontal level, at a distance from each other, as is illustrated e.g. in FIG. 2. In this embodiment, the frame 2 of the fastening device 1; 1a, 1b is attached to the front surface of both fork parts 142a, 142b e.g. by bolts or by welding so that they are positioned essentially vertically. The support frame 110 of the work device 11 is provided with two connection pins 115, 116 that are arranged most preferably on the same imaginary transversal axis and that have a circular cross-section, the pins being at the same distance from each other as the said fastening devices 1; 1a, 1b, especially their frames 2 and slides 3.

When the work vehicle 10 and the work device 11, such as a cutting apparatus, are being attached to each other, the first and second closing part 4, 5 of the frame 2 and slide 3 of the fastening device 1; 1a, 1b are arranged to the open position A. Now the connection pin 115, 116 of the support frame 110 of the work device 11 is arranged into the space reserved for the connection pin between the first and second closing part 4, 5 of the frame 2 and slide 3 of the fastening device 1; 1a, 1b. After this the slide 34 of the fastening device 1; 1a, 1b is moved in relation to the frame 2 so that they reach the closed position B. The connection pin 115, 116 of the support frame 110 of the work device 11 arranged between the closing parts 4, 5 of the fastening device 1; 1a, 1b are closed between the closing parts 4, 5 so that it cannot come loose. Until now the locking means 6 have been in the release position D. The locking means 6 are now turned to the locking position E. The work device 11 has thus been attached to the work vehicle 10. By operating in a reversed order to the above-mentioned, the fastening device 1; 1a, 1b can be opened and, respectively, the work device 11 can be released from the work vehicle 10.

As has been stated above, it is further preferable to arrange the actuator 119, such as an electrically operated cylinder (when an electrically operated work vehicle is concerned) or similar. The actuator 119 is arranged e.g. between the centre of the lower frame part 112 of the support frame 110 and the transverse bracket 142c arranged to the front section 142 of the frame of the work vehicle 10 and connecting the fork parts 142a, 142b. The support frame 110 and by means of it the work vehicle 10 can be rotated with the actuator 119 in relation to the axis travelling through the connection pins 115, 116 of the support frame 110, when the work vehicle and work device have been attached to each other by means of a fastening device according to the present invention.

The invention is not merely restricted to concern the embodiment example shown above, but many variations are possible while remaining within the scope of the inventional idea defined by the patent claims.

1. Fastening device for detachably attaching a supplementary apparatus to the main apparatus, such as a vehicle, work vehicle, construction, building or similar by means of a part belonging to it, such as a rod, pin, projection, shaft or similar, characterised in that the fastening device (1) comprises the longitudinal frame (2) and slide (3), which are attached and fitted to each other so that they can be moved in relation to each other between two positions (A, B), and in connection of which there is provided the first and, respectively, the second closing part (4, 5), by means of which the rod etc. of the supplementary apparatus can be attached to the fastening device and by means of it further to the apparatus etc., and locking means (6) for immovably locking the frame (2) and slide (3) to each other and, respectively, for releasing them from each other.

2. Fastening device according to claim 1, characterised in that the frame (2) is provided with a straight groove (21), into which the slide (3) is fitted so that it can be moved by at least a predefined distance (a) in the groove from the first position (A) to the second position (B) and back, respectively.

3. Fastening device according to claim 2, characterised in that the frame (2) and the slide (3) are attached to each other by at least two, the first and second connection pins (7, 8), through the midpoints of which the motion axis (C-C) travels and which are arranged to travel perpendicularly to the motion axis through the apertures in the frame and slide (25, 31; 26, 32), of which apertures those of the slide (31, 32) are longitudinal with their length corresponding to the length of the distance of motion (a).

4. Fastening device according to claim 1, characterised in that the first (4) and the second closing part (5) in connection with the frame (2) and slide (3) are essentially of the same shape, being hook-like parts, which are arranged opposite to each other.

5. Fastening device according to claim 4, characterised in that the free ends (41, 51) of the first and second closing part (4, 5) are located near each other in the first position (A) and that together they form essentially a closed circle and space (45), inside which the fastening pin or similar can be closed, when again in the second position (B), the free ends (41, 51) of the hook-like closing parts (4, 5) are at a distance from each other so that the fastening pin or similar can be fitted between the closing parts or removed from between the closing parts.

6. Fastening device according to claim 1, characterised in that the locking means (6) comprise the first (61) and second lever (62), which are rotatably connected to each other by the pin (63) from the first end (61a, 62a) of both levers; the second end (61b) of the first lever being rotatably attached to the second connection pin (8) and the second end (62b) of the second lever being rotatably attached to the third connection pin (9), which is located in the upper section of the frame (2) above the slide (3), the midpoint of the axis of the connection pin (9) being located on the line of motion (C-C) or in its proximity, and the locking means (6) being turnable over the motion axis (C-C) from its first side to the second so that the slide (3) can be locked to the second position (B).

7. Fastening device according to claim 6, characterised in that the first lever (61) is constructed by means of two parallel lever arms (611, 612), which are arranged to different sides of the side parts (23, 24) of the frame (2) and, at the same time, of the groove (21), and that the upper part of the first lever (61) is provided with the cover plate (613) connecting the lever arms (611, 612).

8. Work vehicle (10), which comprises the frame (14) and at least three wheels (13), on which the work vehicle rests, and a driving motor, especially an electric motor, which is arranged in contact with one or several wheels for moving the work vehicle, and the work device (11) detachably attached to the frame by two fastening devices (1; 1a, 1b) according to claim 1, the work device (11) comprising the support frame (110) and fastening pins (115, 116), by means of which the attachment is carried out.

9. Work vehicle according to claim 8, characterised in that the longitudinal frames (2) of the two fastening devices (1; 1a, 1b) are attached to the end section of the frame (14) of the work vehicle (10), especially to its front section (142; 142a, 142b) at a distance from each other, and that the support frame (110) of the work device (11) is provided with two connection pins (115, 116) with circular cross-section, arranged on the same imaginary transversal axis and located on average at the same distance from each other as the said fastening devices (1; 1a, 1b), and that upon fastening the work vehicle and the work device, the connection pins (115, 116) of the support frame (110) of the work vehicle (10) are arranged between the first and, respectively, the second closing part (4, 5) of the frame (2) and slide (3) of the fastening device (1), when they are in their first position, i.e. the open position (A), after which the frame (2) and slide (3) are arranged to the second position, i.e. the closed position (B) so that the frame (2) and the slide (3) and the connection pins (115, 116) of the support frame of the work vehicle arranged between their closing parts (4, 5) are attached to each other, simultaneously attaching the work device to the work vehicle.

10. Work vehicle according to claim 8, characterised in that between the support frame (110) of the work device (11) and the work vehicle (10) there is further provided the actuator (119), by means of which the support frame and by means of it the work device can be turned in relation to the axis travelling through the connection pins (115, 116) of the support frame, when the work vehicle and work device are attached to each other by the fastening device (1; 1a, 1b).

11. Fastening device according to claim 2, characterised in that the first (4) and the second closing part (5) in connection with the frame (2) and slide (3) are essentially of the same shape, being hook-like parts, which are arranged opposite to each other.

12. Work vehicle according to claim 9, characterised in that between the support frame (110) of the work device (11) and the work vehicle (10) there is further provided the actuator (119), by means of which the support frame and by means of it the work device can be turned in relation to the axis travelling through the connection pins (115, 116) of the support frame, when the work vehicle and work device are attached to each other by the fastening device (1; 1a, 1b).
